(19) United States
(12) Patent Application Publication
(10) Pub. No.: US 2024/0375476 A1
(43) Pub. Date: Nov. 14, 2024

(54) A BODY FOR A MACHINE COMPRISING A HEATED PAYLOAD CAVITY

(71) Applicant: CATERPILLAR INC., Peoria, IL (US)

(72) Inventor: Mark Stoker, Seaham, County Durham (GB)

(73) Assignee: CATERPILLAR INC., Peoria, IL (US)

(21) Appl. No.: 18/564,175

(22) PCT Filed: May 9, 2022
(86) PCT No.: PCT/US2022/028305

§ 371 Date: Nov. 27, 2023

(30) Foreign Application Priority Data
May 27, 2021 (GB) 2107572.6

(51) Int. Cl. B60H 1/00; B60P 1/28

(52) U.S. Cl. CPC B60H 1/00378; B60P 1/286

(57) ABSTRACT

The body comprises body walls at least partially forming a body cavity for receiving a payload and a flow arrangement for directing heated gas to heat the body cavity and mounted to at least one of the body walls. An inlet chamber wall at least partially forms an inlet chamber having opposing chamber sides. An inlet aperture is located between the chamber sides. Chamber outlet apertures are located at or adjacent to the chamber sides. A baffle is located in the inlet chamber and is configured to direct heated gas entering the inlet chamber from the inlet aperture towards the chamber outlet apertures for exiting the inlet chamber.

### TECHNICAL FIELD

This disclosure is directed towards a body, such as a dump body or an ejector body, for a machine, a machine comprising a body and a method of heating such a body. The body comprises a body cavity for receiving a payload and a flow arrangement for receiving heated gas to heat the body.

### BACKGROUND

Machines, particularly those in construction, mining, earth moving, goods handling, forestry, agriculture or other such industries, often comprise a body, such a dump body or an ejector body, for holding materials so the machine can transport the materials around a worksite or on highways. After the emptying of the payload from the body, some payload may undesirably remain attached to the body. Such “carry back” decreases the efficiency of the machine. The body may therefore comprise an exhaust gas flow path for heating the body to assist in preventing the payload from remaining attached to the body.

U.S. Pat. No. 8,721,006B2 discloses a dump body with an exhaust gas flow path for heating the dump body in order to keep earth and sand from adhering on an inner surface of the body when the earth and sand are unloaded. The dump body includes an exhaust gas flow path including an inner space of a lower rib and an inner space of vertical ribs. The exhaust gas flow path is in communication with a flow-path forming section of a box shape that allows the exhaust gas flowing in the exhaust gas flow path to go downward relative to the lower rib.

### SUMMARY

The present disclosure provides a body for a machine, the body comprising: body walls at least partially forming a body cavity for receiving a payload; and a flow arrangement for directing heated gas to heat the body cavity and mounted to at least one of the body walls, the flow arrangement comprising: an inlet chamber wall at least partially forming an inlet chamber, the inlet chamber comprising opposing first and second chamber sides; an inlet aperture between the first and second chamber sides; first and second chamber outlet apertures located at or adjacent to the first and second chamber sides respectively; and a baffle located in the inlet chamber and configured to direct heated gas entering the inlet chamber from the inlet aperture towards the first and second chamber outlet apertures for exiting the inlet chamber.

The present disclosure further provides a machine comprising a chassis and a body mounted to the chassis, wherein the body comprises: body walls at least partially forming a body cavity for receiving a payload; and a flow arrangement for directing heated gas to heat the body cavity and mounted to at least one of the body walls, the flow arrangement comprising: an inlet chamber wall at least partially forming an inlet chamber, the inlet chamber comprising opposing first and second chamber sides; an inlet aperture between the first and second chamber sides; first and second chamber outlet apertures located at or adjacent to the first and second chamber sides respectively; and a baffle located in the inlet chamber and configured to direct heated gas entering the inlet chamber from the inlet aperture towards the first and second chamber outlet apertures for exiting the inlet chamber.

The present disclosure further provides a method of heating a body for a machine, wherein the body comprises: body walls at least partially forming a body cavity; and a flow arrangement mounted to at least one of the body walls comprising: an inlet chamber wall at least partially forming an inlet chamber, the inlet chamber comprising opposing first and second chamber sides; an inlet aperture between the first and second chamber sides; first and second chamber outlet apertures located at or adjacent to the first and second chamber sides respectively; and a baffle located in the inlet chamber, wherein the method comprises directing heated gas through the inlet aperture into the inlet chamber such that the baffle directs the heated gas towards the first and second chamber outlet apertures and the heated gas exits the inlet chamber via the first and second chamber outlet apertures for heating the body cavity.

By way of example only, embodiments according to the present disclosure are now described with reference to, and as shown in, the accompanying drawings.

### BRIEF DESCRIPTION OF THE DRAWINGS

FIG. 1 is a side elevation of a machine, in this case an articulated vehicle, of the present disclosure;

FIG. 2 is a rear perspective view of a body, in this case a dump body, of the machine of FIG. 1;

FIG. 3 is a top elevation of the body of FIG. 2 with an inlet chamber wall shown as transparent and a baffle, wall support and portions of corners shown in broken lines;

FIG. 4 is a magnified view of a portion of a flow arrangement of the body of FIG. 2 with an inlet chamber wall removed from view to show the features thereunder;

FIG. 5 is a cross-sectional view of the portion of the heating gas flow arrangement of FIG. 4; and

FIG. 6 is a schematic of a method of heating the body of the present disclosure.

### DETAILED DESCRIPTION

The present disclosure is generally directed towards a body for a machine comprising a body cavity for holding a payload. A flow arrangement is mounted inside the body at a front wall thereof. The flow arrangement receives a heated gas in an inlet chamber. A baffle in the inlet chamber directs the heated gas to opposing sides of the inlet chamber and down side chambers along the body for heating payload in the body and reducing carry back. The baffle assists in more evenly spreading the heated gas to corners and assists in preventing the formation of hot spots.

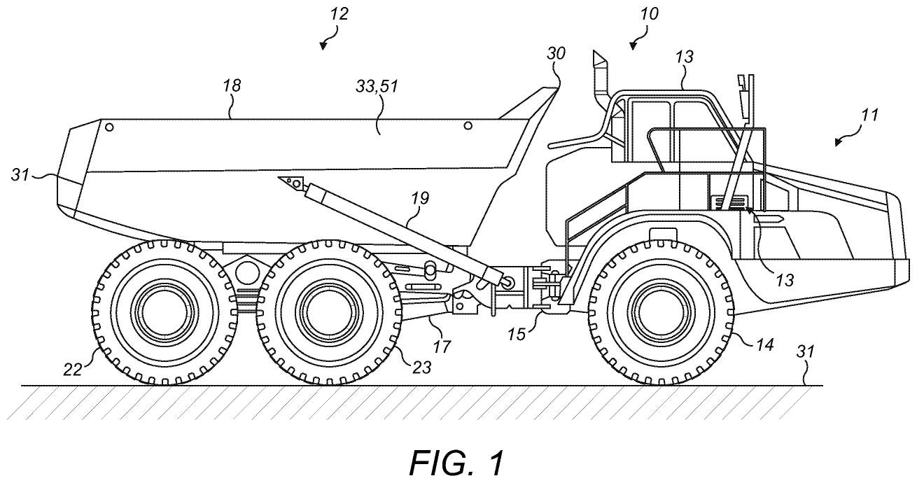

FIG. 1 illustrates a machine 10, which may be a dump truck, comprising a body 18 in accordance with the present disclosure. The machine 10 may be an articulated vehicle as illustrated, although may be a more conventional dump truck having a single chassis or another type of earth moving machine. The machine 10 may comprise a cab frame 11 and a body frame 12 (which may be a trailer unit). The cab frame 11 may be a tractor unit and may be connected to the body frame 12 via a coupling 15, which may be an articulation joint.

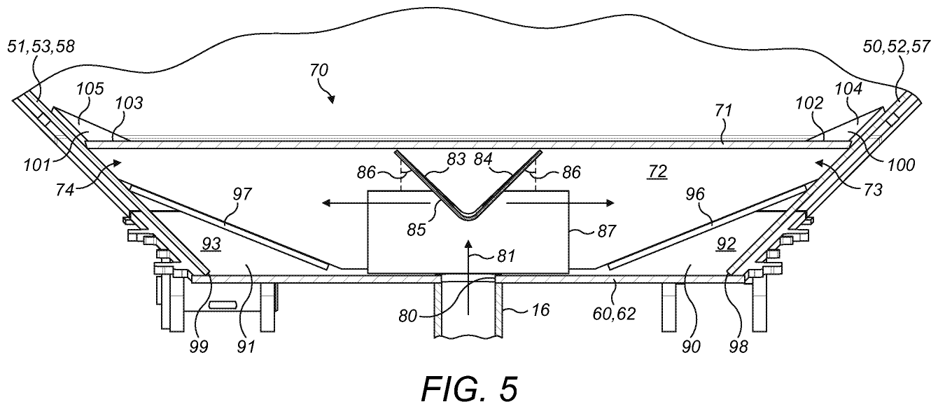

The machine 10 may comprise a power system 13 including a power unit. The power unit may be of any suitable type, such as an internal combustion engine, a micro-turbine or an electric motor. The power unit may provide power to drive the machine 10 over terrain via wheels 14, 22, 23. The machine 10 may comprise an exhaust gas redirection arrangement 16 for directing exhaust gas from the power system 13 to the body 18 for supplying heat to the body 18. Such exhaust gas is heated by the power unit prior to entry into the exhaust gas redirection arrangement 16 (shown in FIG. 5).

The body frame 12 may comprise a chassis 17 and the body 18, which may be mounted to the chassis 17 as illustrated. The body 18 may be a material handling or receiving body and is adapted to receive and hold a load. The body 18 may be a dump body or an ejector body. In the case of the body 18 comprising a dump body as illustrated, the body 18 may be attached to the chassis 17 at a pivot point (not shown) and a tipping system may be provided to rotate the body 18 about the pivot point. The tipping system may comprise at least one hydraulic actuator 19 connected to the body 18 and the chassis 17. Alternatively, the body 18 may comprise an ejector mechanism, having an actuator which may move a plate within the body 18 to eject any material contained therein.

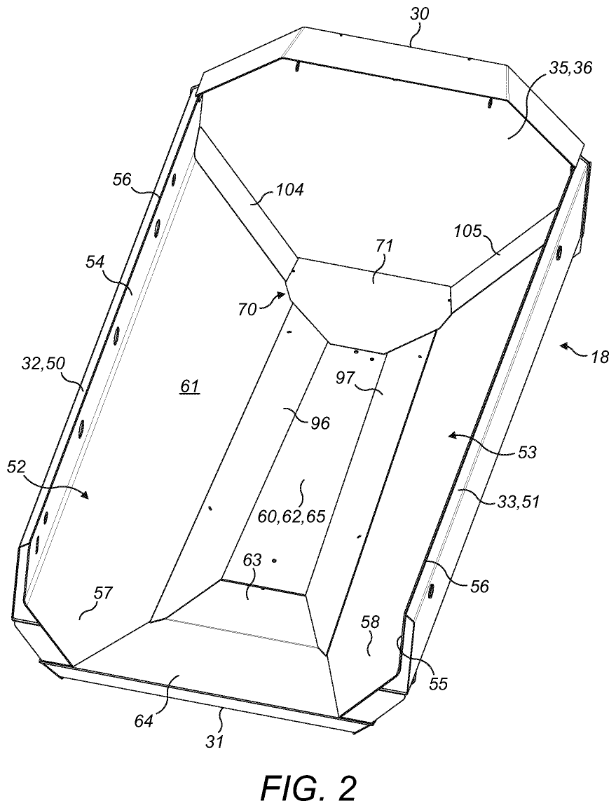

As illustrated further in FIG. 2, the body 18 comprises a front end 30 and a rear end 31 and extends between first and second sides 32, 33 from the front end 30 to the rear end 31. The front end 30 may be located adjacent to the cab frame 11. The body 18 may be configured such that material can be ejected from the body 18 at the rear end 31, such as when the body 18 is tipped by the tipping system or the ejector pushes material out of the body 18.

The body 18 comprises body walls 35, 50, 51, 60, which may comprise a front wall 35, first and second side walls 50, 51 and a base 60. The body walls 35, 50, 51, 60 at least partially form a body cavity 61 for receiving a payload (not shown).

The front wall 35 may be located at the front end 30. The front wall 35 may comprise a front internal surface 36, which may be substantially planar and may slope downwardly in a direction towards the rear end 31 or away from the front end 30 for directing material downwardly.

The first and second side walls 50, 51 may extend from the front wall 35 to the rear end 31. The first and second side walls 50, 51 may form the first and second sides 32, 33 respectively of the body 18. The first and second side walls 50, 51 may extend from the front wall 35 to the rear end 31 and may extend along the height of the body 18. The first and second side walls 50, 51 may comprise substantially the same features, other than being mirrored about a plane extending midway between them.

The base 60 may extend from the front wall 35 to the rear end 31 and between the first and second side walls 50, 51. Therefore, the front wall 35, first and second side walls 50, 51 and base 60 at least partially form a body cavity 61 for receiving material. In particular, the front wall 35, first and second side walls 50, 51 and base 60 may be configured to support the weight of material in the body cavity 61 and prevent such material from falling out of the body cavity 61. The base 60 may have a greater length (the dimension extending between the front and rear ends 30, 31) than width (the dimension extending between the first and second side walls 50, 51) and the body cavity 61 may therefore be elongate.

The base 60 may comprise a lower base portion 62 and/or at least one base sloped portion 63, 64, which may form a base internal surface 65. The lower base portion 62 may be substantially planar and/or rectangular in plan view as illustrated, extending from the front wall 35 towards the rear end 31. The at least one base sloped portion 63, 64 may extend between the lower base portion 62 and the rear end 31 and may be sloped upwardly from the lower base portion 62 to the rear end 31. The at least one base sloped portion 63, 64 may comprise adjacent first and second base sloped portions 63, 64, each having a different gradient, may extend lower than the front wall 35 and may extend partially extending across the rear end 31. The at least one base sloped portion 63, 64 may be for preventing material sliding out of the rear end 31 during transport.

The first and second side walls 50, 51 may comprise first and second sloped side wall portions 52, 53 respectively and may comprise first and second upper side wall portions 54, 55 extending upwardly from the first and second sloped side wall portions 52, 53 to define an upper edge 56 of the first and second side walls 50, 51. The first and second sloped side wall portions 52, 53 may extend from the base 60 to the first and second upper side wall portions 54, 55 and may be sloped downwardly towards the base 60 such that material is directed towards the base 60 by the first and second side walls 50, 51. The first and second sloped and upper side wall portions 52, 53, 54, 55 may form first and second internal side wall surfaces 57, 58 of the first and second side walls 50, 51 respectively.

The body 18 comprises a flow arrangement 70 mounted to at least one of the body walls 35, 50, 51, 60. The flow arrangement 70 is for directing heated gas to heat the body cavity 61 and may be fluidly connected to the exhaust gas redirection arrangement 16 for receiving heated exhaust gas from the power system 13.

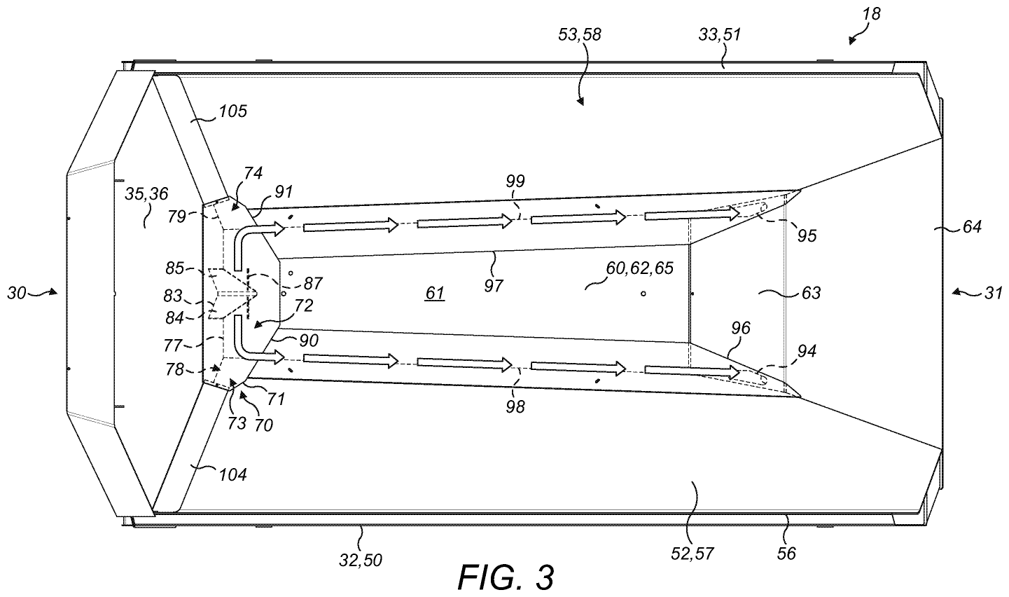

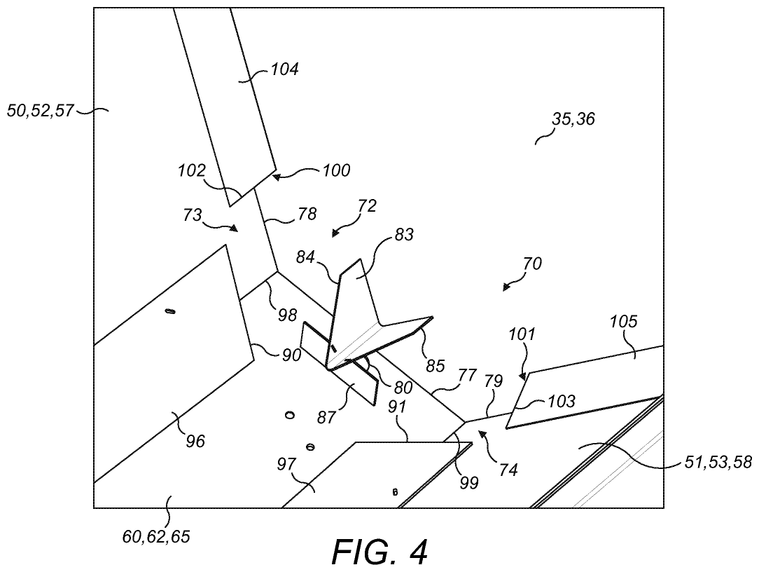

As illustrated in further detail in FIGS. 3 to 5, the flow arrangement 70 comprises an inlet chamber wall 71 at least partially forming an inlet chamber 72. In FIG. 3 elements of the flow arrangement 70 are shown in broken lines and in FIG. 4 the inlet chamber wall 71 is removed from view in order to show the features of the flow arrangement 70. The inlet chamber 72 comprises opposing first and second chamber sides 73, 74 and is configured to receive the heated gas therein.

The inlet chamber wall 71 may be mounted to at least one of the body walls 35, 50, 51, 60 and the inlet chamber 72 may be formed between the inlet chamber wall 71 and at least one of the body walls 35, 50, 51, 60. In particular, the inlet chamber wall 71 may extend between the front wall 35, first and second side walls 50, 51 and/or base 60 such that the inlet chamber 72 is formed therebetween. The inlet chamber wall 71 may extend entirely across a front base corner 77 between the front wall 35 and base 60 and may extend partially across first and second front side corners 78, 79 between the front wall 35 and the first and second side walls 50, 51 respectively. The inlet chamber wall 71 may extend across less than 25% of the area of the front wall internal surface 36 and may extend across less than 25% of the area of the base internal surface 65.

The inlet chamber wall 71 may be configured for supporting a payload in the body cavity 61. The inlet chamber wall 71 may be sloped downwardly from the front wall 35 to the base 60 for directing payload towards the base 60.

The flow arrangement 70 comprises an inlet aperture 80 located between, such as substantially midway between, the first and second chamber sides 73, 74 and configured for heated gas to enter through into the inlet chamber 72. The inlet aperture 80 is in fluid communication with the exhaust gas redirection arrangement 16 and may extend through at least one of the body walls 35, 50, 51, 60, such as the base 60 as illustrated. The inlet aperture 80 may be configured for directing heated gas into the inlet chamber 72 along an inlet flow direction 81. The inlet chamber wall 71 may be arranged opposite the inlet aperture 80 such that the inlet flow direction 81 is from the inlet aperture 80 towards the inlet chamber wall 71.

The flow arrangement 70 comprises first and second chamber outlet apertures 90, 91 located at or adjacent to the first and second chamber sides 73, 74 respectively. The first and second chamber outlet apertures 90, 91 may be adjacent to the first and second side walls 50, 51 and may extend between the inlet chamber wall 71 and the first and second side walls 50, 51 and/or base 60.

The flow arrangement 70 may comprise first and second side chambers 92, 93, which may extend from the first and second chamber outlet apertures 90, 91 to first and second side chamber exit apertures 94, 95 through which heated gas can exit the body 18. The first and second side chamber exit aperture 94, 95 may be located towards the rear end 31 and may extend through the base 60, such as through the at least one base sloped portion 63, 64.

The flow arrangement 70 may comprise first and second side chamber walls 96, 97 for at least partially forming the first and second side chambers 92, 93. The first and second side chamber walls 96, 97 may be configured for supporting a payload in the body cavity 61. The first and second side chamber walls 96, 97 may extend between the base 60 and first and second side walls 50, 51 respectively, and may extend from the inlet chamber wall 71 and/or to the at least one base sloped portion 63, 64, to form the first and second side chambers 92, 93. The first and second side chambers 92, 93 may be formed between the first and second side chamber walls 96, 97, base 60 and the first and second side walls 50, 51. The first and second side chamber walls 96, 97 may at least partially cover first and second base side corners 98, 99 between the base 60 and the first and second side walls 50, 51 respectively.

The flow arrangement 70 comprises a baffle 83 located in the inlet chamber 72 and configured to direct heated gas entering the inlet chamber 72 from the inlet aperture 80 towards the first and second chamber outlet apertures 90, 91 for exiting the inlet chamber 72. The baffle 83 may be mounted opposite the inlet aperture 80 and may be located along the inlet flow direction 81. The baffle 83 may be mounted to the inlet chamber wall 71, such as to an underside thereof facing into the inlet chamber 72. The baffle 83 may be mounted to the front wall 35, such as to the front wall internal surface 36, and may extend between the front wall 35 and the inlet chamber wall 71.

The baffle 83 may comprise first and second baffle sloped surfaces 84, 85 for directing heated gas from the inlet aperture 80 towards the first and second chamber outlet apertures 90, 91 respectively. As illustrated, the first and second baffle sloped surfaces 84, 85 may extend at acute angles 86 to the inlet flow direction 81 and may face in substantially opposite directions. The first and second baffle sloped surfaces 84, 85 may extend substantially parallel to the first and second side walls 50, 51, such as substantially parallel to the first and second sloped side wall portions 52, 53 respectively. The baffle 83 may be substantially V-shaped in cross-section with the lowermost part of the V being closest to the inlet aperture 80.

The flow arrangement 70 comprises a wall support 87 extending from at least one of the body walls 35, 50, 51, 60 to the inlet chamber wall 71 and/or the baffle 83. The wall support 87 may extend from the base 60 to the inlet chamber wall 71 such that the inlet chamber wall 71 is supported in the carrying of a payload by the base 60 via the wall support 87. The wall support 87 may be elongate, extending partway between the first and second side walls 50, 51 as illustrated.

The flow arrangement 70 may further comprise first and second front flow chambers 100, 101 extending from first and second front flow apertures 102, 103 in the inlet chamber 72 for suppling heated gas to the front wall 35. The flow arrangement 70 may comprise first and second front flow walls 104, 105 extending from the inlet chamber 72 over at least a portion of the first and second front side corners 78, 79 not covered by the inlet chamber wall 71. The first and second front flow walls 104, 105 may be mounted to the first and second side walls 50, 51 respectively and the front wall 35 such that the first and second front flow chambers 100, 101 may be formed between the first and second side walls 50, 51 respectively, the front wall 35 and the first and second front flow walls 104, 105.

The body cavity 61 may be formed between portions of the first and second internal side wall surfaces 57, 58, the front internal surface 36 and the base internal surface 65 and the inlet chamber wall 71, first and second side chamber walls 96, 97 and/or the first and second front flow walls 104, 105. The first and second internal side wall surfaces 57, 58, front internal surface 36, inlet chamber wall 71, first and second side chamber walls 96, 97 and/or first and second front flow walls 104, 105 may be sloped to direct payload downwardly towards the base internal surface 65 in use.

The first and second side walls 50, 51, front wall 35, base 60 and flow arrangement 70 may each comprise a plate assembly comprising at least one plate. The body 18 may thus be formed from a plurality of plate assemblies and the at least one plate may be formed from metal, particularly steel. The internal surfaces 36, 57, 58, 61 may be formed of different plates to external surfaces of the body 18.

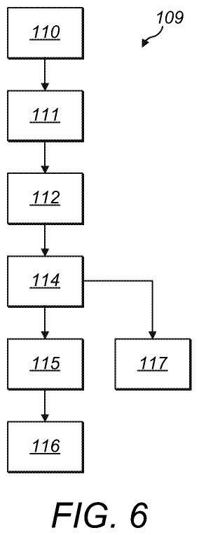

As illustrated in FIG. 6, a method 109 of operation may comprise, in a first step 110, the power system 13 generating heated exhaust gas. In a second step 111 the exhaust gas redirection arrangement 16 directs at least a portion of the exhaust gas to the flow arrangement 70 of the body 18. In a third step 112 the exhaust gas enters the inlet chamber 72 via the inlet aperture 80 along the inlet flow direction 81. In a fourth step 114 the baffle 83 directs the heated gas towards the first and second chamber outlet apertures 90, 91. The baffle 83 may split the flow of exhaust gas and direct a portion of the heated gas towards the first chamber outlet aperture 90 and a portion of the heated gas towards the second chamber outlet aperture 91. In a fifth step 115 the heated gas may flow through the first and second chamber outlet apertures 90, 91 and along the first and second side chambers 92, 93. In a sixth step 116 the heated gas may flow out of the flow arrangement 70 and body 18 by exiting via the first and second side chamber exit apertures 94, 95. Simultaneously, in a seventh step 117 heated gas directed towards the first and second chamber outlet apertures 90, 91 by the baffle 83 may also flow into the first and second front flow chambers 100, 101.

Various other embodiments fall within the scope of the present disclosure. For example, the flow arrangement 70 may not comprise the first and second front flow chambers 100, 101. The inlet aperture 80 may extend through the front wall 35 with the orientation of the baffle 83 adapted accordingly.

### INDUSTRIAL APPLICABILITY

During operation the heated gas in the inlet chamber 72 may heat the inlet chamber wall 71 and the heated gas in the first and second side chambers 92, 93 may heat the first and second side chamber walls 96, 97. The heated gas in the first and second front flow chambers 100, 101 may heat the first and second front flow walls 104, 105. Portions of the body walls 35, 50, 51, 60 adjacent to the inlet chamber wall 71 and first and second side chamber walls 96, 97 may also be heated. As a result, any payload in the body cavity 61 may be heated and carry back may be reduced. For example, any frozen payload may melt, any damp payload may dry, such that it becomes loose and falls from the body 18.

The baffle 83 may assist in preventing the formation of a hot spot on a portion of the surface opposite the inlet aperture 80 and may assist in directing the heating into the corners of the body 18 where payload is most likely to become stuck. Furthermore, the baffle 83 may assist in directing the heated gas substantially evenly and uniformly between the first and second chamber outlet apertures 90, 91 and along the first and second side chambers 92, 93. The more uniform flow of heated gas along the inlet chamber 72 and first and second side chambers 92, 93 may result in more uniform heating of the inlet chamber wall 71 and first and second side chamber walls 96, 97. As a result, more of the body walls 35, 50, 51, 60 may be heated to a sufficiently high temperature to prevent or reduce carry back.

1. A body for a machine, the body comprising:
body walls at least partially forming a body cavity for receiving a payload; and
a flow arrangement for directing heated gas to heat the body cavity and mounted to at least one of the body walls, the flow arrangement comprising:
an inlet chamber wall at least partially forming an inlet chamber, the inlet chamber comprising opposing first and second chamber sides;
an inlet aperture between the first and second chamber sides;
first and second chamber outlet apertures located at or adjacent to the first and second chamber sides respectively; and
a baffle located in the inlet chamber and configured to direct heated gas entering the inlet chamber from the inlet aperture towards the first and second chamber outlet apertures for exiting the inlet chamber.

2. The body of claim 1 wherein the baffle comprises first and second baffle sloped surfaces for directing heated gas from the inlet aperture towards the first and second chamber outlet apertures respectively.

3. The body of claim 2 wherein the inlet aperture is configured for directing heated gas into the inlet chamber along an inlet flow direction, further wherein the first and second baffle sloped surfaces extend at acute angles to the inlet flow direction and face substantially opposite directions.

4. The body of claim 1 wherein the inlet chamber wall is arranged opposite the inlet aperture.

5. The body of claim 4 wherein the inlet chamber is formed between the inlet chamber wall and at least one of the body walls.

6. The body of claim 4 wherein the baffle is mounted to the inlet chamber wall opposite the inlet aperture.

7. The body of claim 6 wherein the flow arrangement comprises a wall support extending from at least one of the body walls to the inlet chamber wall and/or the baffle.

8. The body of claim 1 wherein the flow arrangement comprises first and second side chambers extending from the first and second chamber outlet apertures to first and second side chamber exit apertures through which heated gas can exit the body.

9. The body of claim 8 wherein the flow arrangement comprises first and second side chamber walls for at least partially forming the first and second side chambers, wherein the first and second side chamber walls are configured for supporting a payload in the body cavity.

10. The body of claim 1 wherein the body walls comprise:
a front wall;
first and second side walls extending from the front wall; and
a base extending from the front wall between the first and second side walls such that the front wall, first and second side walls and base wall at least partially form the body cavity.

11. The body of claim 10 wherein:
the flow arrangement comprises first and second side chamber walls for at least partially forming the first and second side chambers, wherein the first and second side chamber walls are configured for supporting a payload in the body cavity; and
the first and second side chamber walls extend between the base and first and second side walls respectively to form the first and second side chambers.

12. The body of claim 10 wherein the inlet chamber wall extends between the front wall, first and second side walls and/or base such that the inlet chamber is formed between the inlet chamber wall, the front wall, first and second side walls and/or base, further wherein the inlet chamber wall is configured for supporting a payload in the body cavity.

13. A machine comprising a chassis and a body mounted to the chassis, wherein the body comprises:
body walls at least partially forming a body cavity for receiving a payload; and
a flow arrangement for directing heated gas to heat the body cavity and mounted to at least one of the body walls, the flow arrangement comprising:
an inlet chamber wall at least partially forming an inlet chamber, the inlet chamber comprising opposing first and second chamber sides;
an inlet aperture between the first and second chamber sides;
first and second chamber outlet apertures located at or adjacent to the first and second chamber sides respectively; and
a baffle located in the inlet chamber and configured to direct heated gas entering the inlet chamber from the inlet aperture towards the first and second chamber outlet apertures for exiting the inlet chamber.

14. A machine as claimed in claim 13 further comprising a power system and an exhaust gas redirection arrangement for directing exhaust gas from the power system to the inlet aperture.

15. A method of heating a body for a machine, wherein the body comprises:
body walls at least partially forming a body cavity; and
a flow arrangement mounted to at least one of the body walls comprising:
an inlet chamber wall at least partially forming an inlet chamber, the inlet chamber comprising opposing first and second chamber sides;
an inlet aperture between the first and second chamber sides;
first and second chamber outlet apertures located at or adjacent to the first and second chamber sides respectively; and
a baffle located in the inlet chamber,
wherein the method comprises directing heated gas through the inlet aperture into the inlet chamber such that the baffle directs the heated gas towards the first and second chamber outlet apertures and the heated gas exits the inlet chamber via the first and second chamber outlet apertures for heating the body cavity.
